(19) United States
(12) Patent Application Publication
(10) Pub. No.: US 2025/0132469 A1
(43) Pub. Date: Apr. 24, 2025

(54) BATTERY CELL

(71) Applicant: GM Global Technology Operations LLC, Detroit, MI (US)

(72) Inventors: Vincent Edward Herrman, Clawson, MI (US); Hwanchul Kim, Dryden, MI (US); Subrahmanyam Goriparti, Troy, MI (US); Masoud MohammadPour, Novi, MI (US)

(21) Appl. No.: 18/490,176

(22) Filed: Oct. 19, 2023

(51) Int. Cl. H01M 50/54; B23K 26/21; B23K 101/36; H01M 50/528; H01M 50/533; H01M 50/536

(52) U.S. Cl. CPC H01M 50/54; B23K 26/21; H01M 50/528; H01M 50/533; H01M 50/536; B23K 2101/36; H01M 2220/20

(57) ABSTRACT

A battery cell has a plurality of first electrode tabs and a plurality of second electrode tabs welded to a current collector. The current collector has a first side surface and a second side surface. Each of the electrode tabs of the plurality of first electrodes are coupled to the first side surface. Additionally, each of the electrode tabs of the plurality of second electrodes are coupled to the second side surface.

### INTRODUCTION

The present disclosure relates to electrode stacks in a battery cell and more particularly to electrode stacks configured to reduce heat generation and reduce footprint.

A rechargeable energy storage system (RESS), for example a prismatic battery cell, typically includes a plurality of electrode stacks. Each of the electrode stacks includes anode electrode tabs and cathode electrode tabs extending from the electrode stack. The electrode tabs of the electrode stacks may be connected to multiple current collectors. The current collectors are metal plates that consolidate and transmit the electric current generated by the electrode stacks to the terminals on the battery cell. However, multiple current collectors occupy a large footprint within the battery cell. The electrode stacks and current collectors are placed next to one another, typically in a case or enclosure to protect the electrode stacks from the ambient environment. As electrical current passes through the anode electrode tabs and the cathode electrode tabs, electrical resistance generates heat. Increasing temperature over one or more electrode stacks due to excessive heat generation may cause the entire RESS to increase in temperature, resulting in RESS underperformance or failure.

While prior art methods and systems attempt to minimize heat generation and footprint of the current collectors and may achieve their particular purpose, a need still exists for a new and improved system for reducing heat generation within the electrode stacks while minimizing the footprint current collectors. Accordingly, a battery cell having electrode stacks and current collectors that are configured to minimize heat generation and footprint of the current collectors within the battery cell are needed.

### SUMMARY

According to several aspects of the present disclosure, a battery cell having a plurality of first electrode tabs and a plurality of second electrode tabs welded to a current collector is provided. The battery cell includes a plurality of first electrodes, a plurality of second electrodes, and a current collector. Each of the plurality of first electrodes has an electrode tab, and each of the plurality of second electrodes has an electrode tab. Additionally, the current collector has a first side surface and a second side surface, wherein each of the electrode tabs of the plurality of first electrodes are coupled to the first side surface, and wherein each of the electrode tabs of the plurality of second electrodes are coupled to the second side surface.

In accordance with another aspect of the disclosure, the battery cell includes a first side surface having a plurality of surface portions for coupling each tab of the plurality of first electrodes.

In accordance with another aspect of the disclosure, the battery cell includes a second side surface having a single surface portion for coupling each tab of the plurality of second electrodes.

In accordance with another aspect of the disclosure, the battery cell includes electrode tabs of the plurality of second electrodes wrapped onto the second side surface and stacked together.

In accordance with another aspect of the disclosure, the battery cell includes electrode tabs of the plurality of first electrodes separated into groups. Each group is coupled to the first side surface of the current collector, and the plurality of first electrodes includes between 80 and 90 percent of the electrodes.

In accordance with another aspect of the disclosure, the battery cell includes electrode tabs of the plurality of second electrodes coupled to the second side surface, which are bent in an opposite direction from the electrode tabs of the plurality of first electrodes coupled to the first side surface.

In accordance with another aspect of the disclosure, the battery cell includes a first side surface having weld surface portions to which the electrode tabs of the plurality of first electrodes are coupled.

In accordance with another aspect of the disclosure, the battery cell includes a current collector between 0.4 millimeters and 1 millimeter in thickness.

In accordance with another aspect of the disclosure, the battery cell includes a first side of the current collector facing the electrode stack. A second side of the current collector faces away from the electrode stack.

In accordance with another aspect of the disclosure, the battery cell includes a current collector at a distance of 3 millimeters from the electrode stack.

In accordance with another aspect of the disclosure, the battery cell includes electrode tabs of the plurality of first electrodes coupled to the current collector with a set of parallel welds on the first side surface. The set of parallel welds includes between five and ten welds.

In accordance with another aspect of the disclosure, the battery cell has electrode tabs of the plurality of second electrodes coupled to the current collector with a single weld on the second side surface. The single weld is perpendicular to the set of parallel welds.

In accordance with another aspect of the disclosure, the battery cell includes electrode tabs of the plurality of first electrodes and electrode tabs of the plurality of second electrodes coupled to the current collector with laser welds.

In accordance with another aspect of the disclosure, the battery cell further includes a plurality of electrode tabs of a plurality of third electrodes and a plurality of electrode tabs of a plurality of fourth electrodes extending from a second side of an electrode stack. The battery cell also includes a second current collector having a third surface and a fourth surface. Each of the electrode tabs of the plurality of third electrodes are coupled to the third side surface, and each of the electrode tabs of the plurality of fourth electrodes are coupled to the fourth side surface.

In accordance with another aspect of the disclosure, the battery cell includes a second side of the battery cell opposite the first side of the battery cell.

According to an aspect of the present disclosure, a vehicle having a battery pack is provided. The vehicle having the battery pack includes a plurality of first electrodes, a plurality of second electrodes, and a current collector. Each of the plurality of first electrodes has an electrode tab, and each of the plurality of second electrodes has an electrode tab. Additionally, the current collector has a first side surface and a second side surface, wherein each of the electrode tabs of the plurality of first electrodes are coupled to the first side surface, and wherein each of the electrode tabs of the plurality of second electrodes are coupled to the second side surface.

In accordance with another aspect of the disclosure, the vehicle having a battery pack includes electrode tabs of the plurality of first electrodes including between 80 and 90 percent of the electrode tabs. The electrode tabs of the plurality of second electrodes includes between 10 and 20 percent of the electrode tabs.

According to an aspect of the present disclosure, a method of laser welding electrode tabs to a current collector is provided. The method includes sweeping a plurality of first electrode tabs of a plurality of first electrodes and a plurality of second electrode tabs of a plurality of second electrodes in a first weld direction. Additionally, the method includes laser welding the plurality of first electrode tabs to a first side surface of the current collector. The method also includes bending the plurality of second electrode tabs overtop the current collector to a second side surface in a second weld direction. Further, the method includes laser welding the plurality of second electrode tabs to the second side surface of the current collector, and the second side surface is opposite the first side surface.

In accordance with another aspect of the disclosure, the method includes laser welding the plurality of first electrode tabs to a first side of the current collector, which further includes laser welding between 80 and 90 percent of the first electrode tabs.

In accordance with another aspect of the disclosure, the method includes bending between 10 and 20 percent of the second electrode tabs.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack having a plurality of battery cells, in accordance with the present disclosure.

FIG. 2A is a perspective view illustrating a battery cell disposed within the battery pack shown in FIG. 1, where the battery cell includes at least one electrode stack having a plurality of first electrode tabs and a plurality of second electrode tabs laser welded to a current collector, in accordance with the present disclosure.

FIG. 2B is a partial cross-sectional view through the battery cell, as indicated in FIG. 2A, illustrating the layers in a single electrode stack, in accordance with the present disclosure.

FIG. 3 is a top view illustrating the electrode stack, a plurality of electrode tabs, and a plurality of current collectors shown in FIG. 2, wherein the plurality of first electrode tabs and the plurality of second electrode tabs extend from a first side of the electrode stack, and a plurality of third electrode tabs and a plurality of fourth electrode tabs extend from a second side of the electrode stack, in accordance with the present disclosure.

FIG. 4 is a side view illustrating the battery cell shown in FIG. 2, wherein the plurality of first portions of the electrode tabs is welded to the current collector with a set of parallel laser welds, and the plurality of second portions of the electrode tabs is welded to the current collector with a single laser weld that is perpendicular to the set of parallel laser welds, in accordance with the present disclosure.

FIG. 5 is a flowchart illustrating a method for laser welding the anode and cathode electrode tabs to the current collectors, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

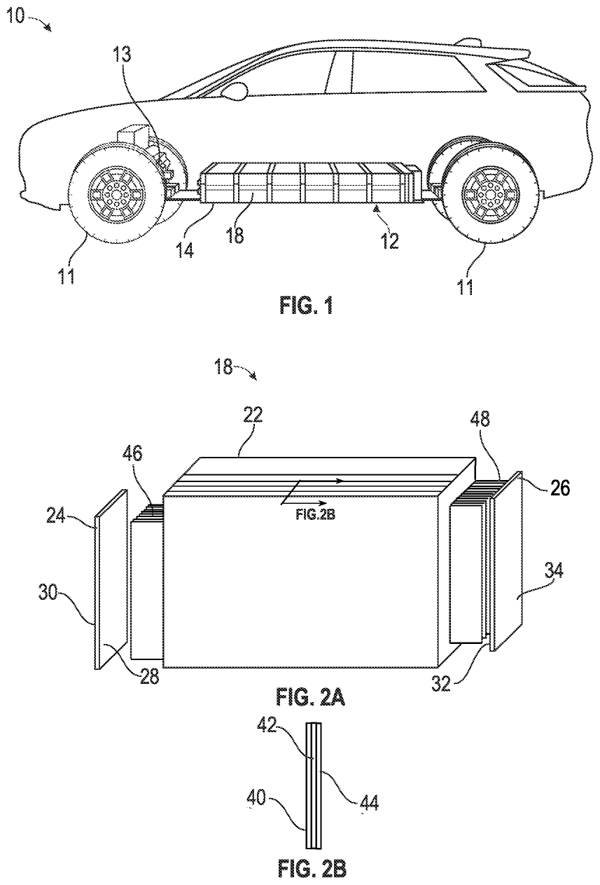

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive motive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. The battery pack 12 may have fifty or more battery cells 18.

Referring now to FIG. 2A, a perspective view of a battery cell 18 disposed within the battery pack 12 shown in FIG. 1 is illustrated, in accordance with an aspect of the present disclosure. Each battery cell 18 has a housing or case (not shown) and a plurality of electrode stacks 22. Each battery cell 18 may have hundreds of electrode stacks 22. Each electrode stack 22 is connected to a current collector 24, 26. Moreover, electrode stacks 22 are placed in the housing and the housing is filled with a suitable electrolyte. For example, the electrolyte is a liquid solution of organic solvents and lithium salts. Current collectors 24, 26 are thin metal plates or foils disposed on either side of the electrode stacks 22 typically having a thickness of between 0.4 and 1 millimeter. The current collectors may be made of copper or aluminum, for example. The current collectors 24, 26 are attached to the electrode stacks, as will be described in further detail below, to transmit the electric current to an external circuit. Moreover, current collector 24 has a first side surface 28 and a second side surface 30. The current collector 26 has a first side surface 32 and a second side surface 34.

With additional reference to FIG. 2B, a partial cross-sectional view through the battery cell 18, as indicated in FIG. 2A, illustrates the layers in a single electrode stack 22, in accordance with the present disclosure. Each electrode stack 22 is comprised of a negative electrode or anode electrode 40 extending from a first side of the electrode stack 22, a separator 42, and positive electrode or cathode electrode 44 extending from a second side of the electrode stack 22. The anode electrode 40 is generally a thin metal plate or foil that includes an anode electrode tab 46 (shown in FIG. 2A) for providing an electrical connection between the anode electrode and current collector 24. Similarly, cathode electrode 44 is a thin metal plate or foil that includes a cathode electrode tab 48 for providing an electrical connection between the cathode electrode 44 and current collector 26.

The anode electrode 40 and the anode electrode tab 46 are made, for example, of copper or other suitable material and typically coated with graphite or graphite/silicon or other carbon-based materials or silicon oxide or lithiated silicon. The cathode electrode 44 and cathode electrode tab 48 are made, for example, of aluminum or other suitable material and typically coated with a metal oxide, such as Lithium cobalt oxide (LCO) or nickel-cobalt-aluminum (NCA) or lithium iron/manganese phosphate (LFP/LFMP) or Lithium manganese rich (LMR). The different metals (copper anode and aluminum cathode) of battery cell 18 produce a galvanic reaction in battery cell 18. The copper, for example, of anode electrode 40, and the aluminum, for example, of cathode electrode 44, have different standard reduction potentials and are separated by one another by the separator 42. The aluminum having the lower potential will oxidize and release electrons, while the copper having a higher potential will reduce and accept electrons. This process of releasing and accepting electrons generates an electric current that may be used to power devices.

The separator 42 is generally a thin a porous membrane or layer of material that is positioned between the anode electrode 40 and the cathode electrode 44 and prevents the anode electrode 40 and cathode electrode 44 from touching and causing a short circuit. The separator allows the lithium ions to pass through and complete the circuit. A composite material that is porous and chemically stable such as composites made with polyethylene (PE), polypropylene (PP) or other natural materials of the like may be used as the separator 42. Moreover, inorganic nanoparticles such as TiO₂, SiO₂, Al₂O₃ and ZrO₂ may also be used to create coating composites for separator 42. Separator 42 increases the internal resistance of battery cell 18 that reduces power output and efficiency of the battery. The internal resistance depends on the thickness porosity and composition of the separator 42. The separator 42 is also selected to withstand high temperatures and manage thermal runaway preventing an uncontrollable rise in temperature due to exothermic reactions. Moreover, the separator 42 has a high melting point and a low shrinkage rate to avoid contact between the anode electrode 40 and cathode electrode 44. The separator 42 has sufficient mechanical strength to resist puncture, tear, or deformation during fabrication and operation of cell assembly. The separator 42 also is dimensionally stabile and flexible to conform to the shape of the electrodes and accommodate volume changes during cycling. The separator 42 is chemically inert and compatible with the electrolyte, electrodes and other cell components. Additionally, separator 42 has a low affinity for water or other impurities that can contaminate the electrolyte or cause corrosion of the electrodes.

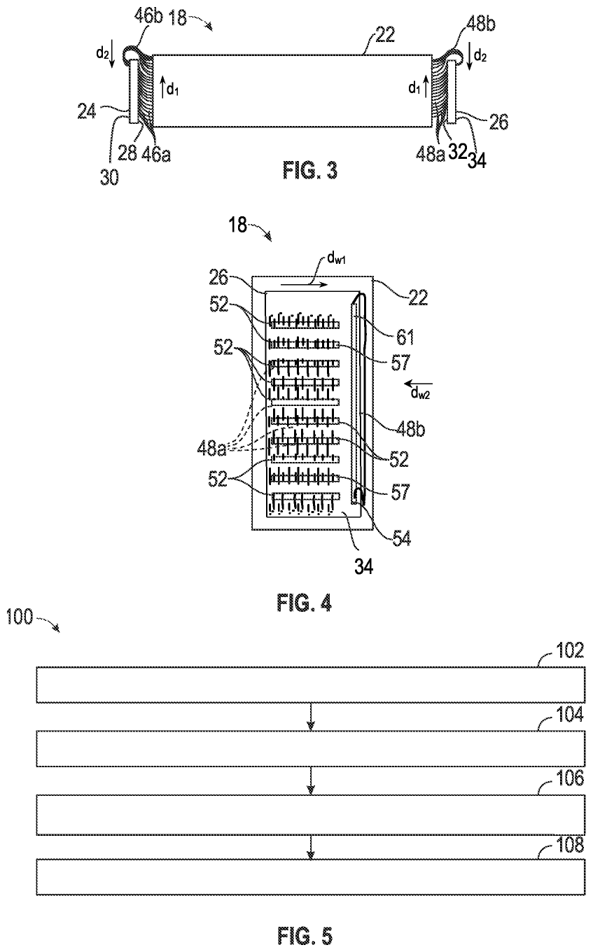

Referring now to FIG. 3, a top view of the electrode stacks 22, electrode tabs 46, 48 and current collectors 24, 26 are illustrated, in accordance with the present disclosure. A first portion of the anode electrode tabs 46a (e.g., between 80 and 90 percent of the electrode tabs, 80-90 electrode tabs) are bent or swept in a first direction d1 and a second portion of the anode electrode tabs 46b (e.g., between 10 and 20 percent of the electrode tabs, 10-20 electrode tabs) are swept (bent) in an opposite direction d2. The first portion of the anode electrode tabs 46a are welded (e.g., laser-welded) to the first side surface 28 of the current collector 24. The first portion of electrode tabs 46a may be separated into groups (e.g., a group of 10 electrode tabs), wherein each group is coupled or welded to the first side surface 28 of the current collector 24. The first side surface 28 is proximate to and faces the electrode stacks 22, and, in a specific example, is a distance of 3 millimeters from the electrode stacks 22. It will be appreciated that the current collector 24 may be spaced at various other distances (e.g., 2 mm, 2.5 mm, 3.5 mm, and so forth) from electrode stacks 22. In contrast, the second portion of the anode electrode tabs 46b of electrode stacks 22 are swept in an opposite direction d2 and bent over and around the current collector 24. The second portion of the anode electrode tabs 46b bent around the current collector 24 are welded to the second side surface 30 of the current collector 24.

Similarly, a first portion of the cathode electrode tabs 48a (e.g., 80-90 percent of the overall cathode electrode tabs, between 80 and 90 tabs) are bent or swept in a first direction d1 and a second portion of the cathode electrode tabs 48b (e.g., 10-20 percent of the overall cathode electrode tabs, between 10 and 20 tabs) are swept in an opposite direction d2. The first portion of the cathode electrode tabs 48a are welded (e.g., laser-welded) to the first side surface 32 (i.e., a third side surface) of the current collector 26 (i.e., a second current collector). The first side surface 32 is proximate to and faces the electrode stacks 22, and, in a specific example, is a distance of 3 millimeters from the electrode stacks 22. It will be appreciated that the current collector 26 may be spaced at various other distances (e.g., 2 mm, 2.5 mm, 3.5 mm, and so forth) from electrode stacks 22. Accordingly, the second portion of the cathode electrode tabs 48b of electrode stacks 22 are swept in an opposite direction d2 and then bent over and around the current collector 26 to the second side surface 34 (i.e., fourth side surface opposite the third side surface) of the current collector 26. The second portion of the cathode electrode tabs 48b bent around the current collector 26 is welded to the second side surface 34 of the current collector 26.

Referring now to FIG. 4, a side view of the battery cell 18 is provided illustrating the attachment of the first and second portions of the cathode electrode tabs 48a, 48b to the current collector 26, in accordance with the present disclosure. More specifically, the first portion of the cathode electrode tabs 48a are welded to the first side surface 32 of the current collector 26 (indicated by dashed-lines in FIG. 4 and as described above and shown in FIG. 3) with a set of parallel welds 52. Each parallel weld 52 is located at a surface portion 57 (weld surface portions) of the first side surface 32. Parallel welds 52 are swept across the current collector 26 in a first weld direction d_{w1}. In an aspect of the present disclosure, as shown in FIG. 4, first portion of the cathode electrode tabs 48a are welded to the first side surface 32 of the current collector 26 through a series of ten parallel welds 52. However, in other aspects of the present disclosure it is contemplated that there may be fewer (i.e., five or less) parallel welds 52 or more (i.e., twelve or more) parallel welds 52.

Moreover, the second portion of the electrode tabs 48b are welded to the second side surface 34 of the current collector 26 with a single weld 54. The single weld 54 is located at a surface portion 61 of the second side surface 34. Single weld 54 is swept across the current collector 26 in a second weld direction d_{w2}. The second weld direction d_{w2} is perpendicular to the first weld direction d_{w1}. For example, the set of parallel welds 52 and the single weld 54 are laser welds.

Accordingly, the first portion of the anode electrode tabs 46a are welded to the first side surface 28 of current collector 24 in a similar manner as described with respect to the first portion of the cathode electrode tabs 48a on the first side surface 32 of current collector 26. Likewise, the second portion of the anode electrode tabs 46b are welded to the second side surface 30 of current collector 24 in a similar manner as described above with respect to the second portion of the cathode electrode tabs 48b on the second side surface 34 of current collector 26.

Referring now to FIG. 5, a flowchart illustrating a method 100 for laser welding the anode and cathode electrode tabs 46a, 46b and 48a, 48b to the current collectors 24, 26 is presented, in accordance with the present disclosure. The method starts at block 102 where the first and second portions of anode and cathode electrode tabs 46a, 48a are swept in a first direction d_{w1} and then the second portion of the anode and cathode electrode tabs 46b, 48b are swept in the second direction d_{w2}. Sweeping the electrode tabs 46a, 46b, 48a, 48b includes using, for example, a clamp tool and/or a welding machine to at least partially sweep and/or bend the first anode and cathode electrode tabs 46a, 48a and the second anode and cathode electrode tabs 46b, 48b in the first direction in a lap-joint configuration, for example. In the lap-joint configuration, the ends of the first electrode tabs 46a, 48a overlap each other as they are swept and/or bent. The first direction d_{w1} includes a direction that is parallel to a surface of the electrode stack 22 from which the plurality of first anode and cathode electrode tabs 46a, 48a and the plurality of the second electrode tabs 46b, 48b extend.

The method then moves to block 104. Block 104 depicts laser welding the plurality of first anode and cathode electrode tabs 46a, 48a to the first side surface 28, 32. Laser welding the plurality of first anode and cathode electrode tabs 46a, 48a includes using a laser welder, for example. The laser welder welds between 80-90 percent of the first anode and cathode electrode tabs 46a, 48a (e.g., 80 and 90 electrode tabs) to the first side surface 28, 32 of the current collector 24, 26, resulting in a set of between 5 and 10 parallel welds 52.

Next, Block 106 depicts bending the plurality of second anode and cathode electrode tabs 46b, 48b overtop the current collector 24, 26 in a second weld direction d_{w2}. Bending the plurality of second anode and cathode electrode tabs 46b, 48b includes using, for example, a clamp tool and/or a welding machine to bend 10-20 percent of the second anode and cathode electrode tabs 46b, 48b (e.g., between 10-20 electrode tabs) over a side of the current collector 24, 26 to prepare the second anode and cathode electrode tabs 46b, 48b for welding to a second side surface 30, 34 of the current collector 24, 26. The second side surface 30, 34 faces away (e.g., distal) from the electrode stack 22.

Then block 108 depicts laser welding the plurality of second anode and cathode electrode tabs 46b, 48b to the second side surface 30, 34 of the current collector 24, 26. Laser welding the plurality of second anode and cathode electrode tabs 46b, 48b includes using a laser welder. The laser welder welds the second anode and cathode electrode tabs 46b, 48b on a single weld 54. The resulting single weld 54 of the second anode and cathode electrode tabs 46b, 48b is oriented perpendicular to the parallel welds 52 of the first anode and cathode electrode tabs 46a, 48a, but on the second side surface 30, 34.

The present disclosure has many advantages and benefits over prior art battery cells. For example, welding the first portion 46a, 48a of the electrode tabs 46, 48 to the first side surface 28, 32 of the current collector 24, 26 and then sweeping and welding the second portion 46b, 48b of the electrode tabs 46, 48 to the second side surface 30, 34 of the current collector 24, 26 allows for one current collector 24, 26 to be used for the plurality of anode electrode tabs 46 and one current collector 24, 26 to be used for the plurality of cathode electrode tabs 48. Having one current collector 24, 26 instead of multiple current collectors for each plurality of tabs 46, 48 reduces overall electrical resistance within the battery cell, thus reducing heat generation. Moreover, eliminating the need for multiple current collectors reduces the footprint of the current collectors within the battery cell.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery cell comprising:
a plurality of first electrodes, wherein each of the plurality of first electrodes has an electrode tab;
a plurality of second electrodes, wherein each of the plurality of second electrodes has an electrode tab; and
a current collector having a first side surface and a second side surface, wherein each of the electrode tabs of the plurality of first electrodes are coupled to the first side surface, and wherein each of the electrode tabs of the plurality of second electrodes are coupled to the second side surface.

2. The battery cell of claim 1, wherein the first side surface has a plurality of surface portions for coupling each tab of the plurality of first electrodes.

3. The battery cell of claim 1, wherein the second side surface has a single surface portion for coupling each tab of the plurality of second electrodes.

4. The battery cell of claim 1, wherein the electrode tabs of the plurality of second electrodes are wrapped onto the second side surface and are stacked together.

5. The battery cell of claim 1, wherein the electrode tabs of the plurality of first electrodes are separated into groups, wherein each group is coupled to the first side surface of the current collector, and wherein the plurality of first electrodes includes between 80 and 90 percent of the plurality of the first and second electrodes.

6. The battery cell of claim 1, wherein the electrode tabs of the plurality of second electrodes coupled to the second side surface are bent in an opposite direction from the electrode tabs of the plurality of first electrodes coupled to the first side surface.

7. The battery cell of claim 1, wherein the first side surface includes weld surface portions that the electrode tabs of the plurality of first electrodes are coupled.

8. The battery cell of claim 1, where the current collector is between 0.4 millimeters and 1 millimeter in thickness.

9. The battery cell of claim 1, where the first side surface of the current collector faces an electrode stack, and the second side surface of the current collector faces away from the electrode stack.

10. The battery cell of claim 1, where a distance from the current collector to an electrode stack is 3 millimeters.

11. The battery cell of claim 1, where the electrode tabs of the plurality of first electrodes are coupled to the current collector with a set of parallel welds on the first side surface, and wherein the set of parallel welds includes between five and ten welds.

12. The battery cell of claim 11, where the electrode tabs of the plurality of second electrodes are coupled to the current collector with a single weld on the second side surface, and wherein the single weld is perpendicular to the set of parallel welds.

13. The battery cell of claim 1, where the electrode tabs of the plurality of first electrodes and the electrode tabs of the plurality of second electrodes are coupled to the current collector with laser welds.

14. The battery cell of claim 1, further comprising:
a plurality of electrode tabs of a plurality of third electrodes and a plurality of electrode tabs of a plurality of fourth electrodes extending from a second side of an electrode stack; and
a second current collector having a third side surface and a fourth side surface, wherein each of the electrode tabs of the plurality of third electrodes are coupled to the third side surface, and wherein each of the electrode tabs of the plurality of fourth electrodes are coupled to the fourth side surface.

15. The battery cell of claim 14, where the second side of the battery cell is opposite the first side of the battery cell.

16. A vehicle having a battery pack, the battery pack comprising:
a plurality of battery cells, wherein each of the plurality of battery cells includes
a plurality of first electrodes, wherein each of the plurality of first electrodes has an electrode tab;
a plurality of second electrodes, wherein each of the plurality of second electrodes has an electrode tab; and
a current collector having a first side surface and a second side surface, wherein each of the electrode tabs of the plurality of first electrodes are coupled to the first side surface, and wherein each of the electrode tabs of the plurality of second electrodes are coupled to the second side surface.

17. The vehicle having a battery pack in claim 16, wherein the electrode tabs of the plurality of first electrodes includes between 80 and 90 percent of the electrode tabs, and wherein the electrode tabs of the plurality of second electrodes includes between 10 and 20 percent of the electrode tabs.

18. A method of laser welding electrode tabs to a current collector, comprising:
sweeping a plurality of first electrode tabs of a plurality of first electrodes and a plurality of second electrode tabs of a plurality of second electrodes in a first weld direction;
laser welding the plurality of first electrode tabs to a first side surface of the current collector;
bending the plurality of second electrode tabs overtop the current collector to a second side surface in a second weld direction; and
laser welding the plurality of second electrode tabs to the second side surface of the current collector, wherein the second side surface is opposite the first side surface.

19. The method of laser welding electrode tabs to the current collector in claim 18, wherein laser welding the plurality of first electrode tabs to the first side surface of the current collector includes laser welding between 80 and 90 percent of the first electrode tabs.

20. The method for laser welding electrode tabs to the current collector in claim 18, wherein bending the plurality of second electrode tabs includes bending between 10 and 20 percent of the second electrode tabs.
